(19) United States
(12) Patent Application Publication
(10) Pub. No.: US 2015/0006934 A1
(43) Pub. Date: Jan. 1, 2015

(54) INFORMATION PROCESSING APPARATUS AND INFORMATION PROCESSING METHOD

(71) Applicant: Kabushiki Kaisha Toshiba, Tokyo (JP)

(72) Inventors: Yasuyuki MIZUURA, Tokyo (JP); Yoshihiro KANEKO, Fussa-shi (JP)

(73) Assignee: Kabushiki Kaisha Toshiba, Tokyo (JP)

(21) Appl. No.: 14/286,686

(22) Filed: May 23, 2014

(30) Foreign Application Priority Data
Jun. 27, 2013 (JP) 2013-134794

(51) Int. Cl. G06F 1/32

(52) U.S. Cl. CPC G06F 1/3234
USPC 713/323

(57) ABSTRACT

According to one embodiment, an information processing apparatus includes a setting module, an estimation module, a receiver, and a display processor. The setting module sets the apparatus in a power saving state, based on one or more values corresponding to one or more power saving setting items. The estimation module estimates a first saved power amount saved by the apparatus in the power saving state in a first period. The receiver receives an average saved power amount between the first saved power amount and a second saved power amount from a server, the second saved power being saved by a second apparatus in the power saving state in a second period. The display processor displays the first saved power amount and the received average saved power amount on a screen.

### CROSS-REFERENCE TO RELATED APPLICATIONS

This application is based upon and claims the benefit of priority from Japanese Patent Application No. 2013-134794, filed Jun. 27, 2013, the entire contents of which are incorporated herein by reference.

### FIELD

Embodiments described herein relate generally to a technique for power saving.

### BACKGROUND

In recent years, various information processing apparatuses, such as a personal computer (PC), a tablet and a smartphone, have been developed. Most of such information processing apparatuses include power saving functions. The power saving function is a function for setting an operational environment which affects a power amount consumed by the system. The power saving function is also called “power management function”. The user performs power saving setting on some power saving setting items in the PC to reduce the power consumption of the PC.

Recently, attention has been paid to the power saving function of the PC, from the standpoint of saving energy. If the power saving functions of PCs in homes or PCs in companies are properly used, it is possible to save a great amount of power, contributing to power saving (ecology).

In addition, recently, a technique has begun to be developed for presenting to users the indices which indicate how much a present instantaneous power saving setting value contributes to power saving.

However, even if a PC is set in a power saving state temporarily, it is difficult to contribute to power saving (ecology). This is because the power consumption of the PC depends on the cumulative states of daily use of the PC. It is thus necessary to realize a novel function for prompting the user to use the PC in the power saving state continuously.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view for describing a system including information processing apparatuses (client computers) according to an embodiment, and a server for comparing degrees of contribution to power saving between the client computers.

FIG. 2 is an exemplary perspective view illustrating an external appearance of the information processing apparatus of the embodiment.

FIG. 3 is an exemplary block diagram illustrating a system configuration of the information processing apparatus of the embodiment.

FIG. 4 is an exemplary block diagram illustrating a functional configuration of a power saving utility executed by the information processing apparatus of the embodiment.

FIG. 5 is a view illustrating a structure example of power log data used by the information processing apparatus of the embodiment.

FIG. 6 is a view illustrating a structure example of power log data stored by the server of FIG. 1.

FIG. 7 is a view illustrating a structure example of analysis data generated by the server of FIG. 1.

FIG. 8 is a view illustrating an example of a power saving result display screen displayed by the information processing apparatus of the embodiment.

FIG. 9 is a view illustrating an example of a screen displaying a transition of a power saving result, the screen being displayed by the information processing apparatus of the embodiment.

FIG. 10 is a flowchart illustrating an example of the procedure of a power saving result display process executed by the information processing apparatus of the embodiment.

### DETAILED DESCRIPTION

Various embodiments will be described hereinafter with reference to the accompanying drawings.

In general, according to one embodiment, an information processing apparatus includes a setting module, an estimation module, a receiver, and a display processor. The setting module is configured to set the information processing apparatus in a power saving state, based on one or more power saving setting values corresponding to one or more power saving setting items, the one or more values being set by a user. The estimation module is configured to estimate a first saved power amount saved by the information processing apparatus in the power saving state in a first period. The receiver is configured to receive an average saved power amount between the first saved power amount and a second saved power amount from a server, the second saved power being saved by a second information processing apparatus in the power saving state in a second period. The display processor is configured to display the first saved power amount and the received average saved power amount on a screen.

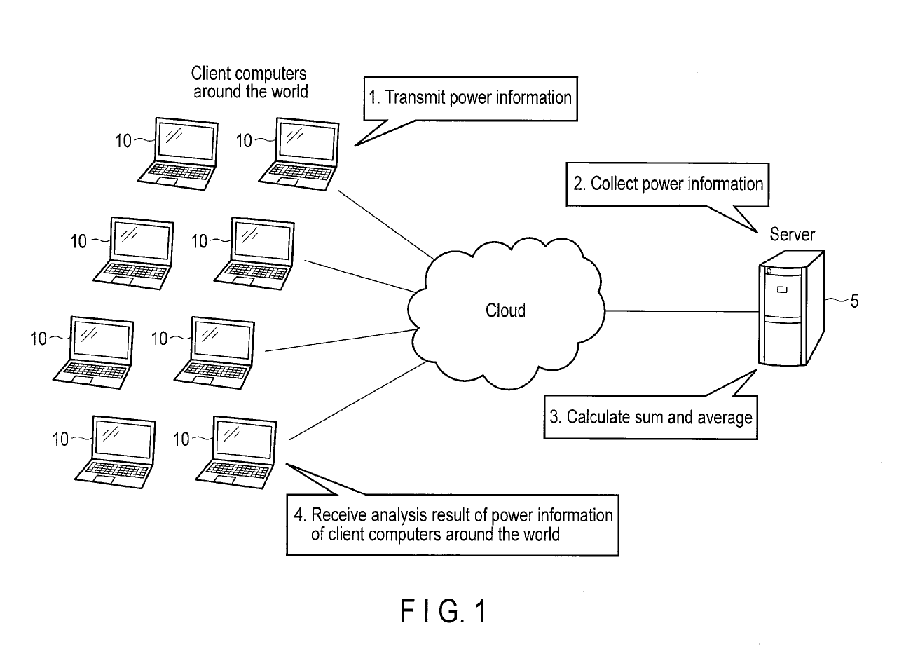

FIG. 1 illustrates a system which presents a degree of contribution to power saving to an information processing apparatus according to an embodiment. This information processing apparatus is an electronic apparatus such as a personal computer (PC), a PDA, a tablet, a smartphone, or a TV. In the description below, this information processing apparatus is also referred to as client computer 10.

As illustrated in FIG. 1, in this system, a plurality of client computers 10 and a server computer 5 operate in cooperation, and a degree of contribution to power saving is presented to each client computer 10. The plural client computers 10 are, for example, computers around the world, or computers belonging to a predetermined group (segment) (e.g. client computers used in a certain company, client computers used in a certain region, or computers manufactured by a certain manufacturer).

Each of the plural client computers 10 transmits to the server computer 5 power information including a power consumption amount and a saved power amount of the client computer 10. The respective client computers 10 may be used in various countries or regions of the world, and it is possible that these client computers 10 are used in different time zones (i.e. it is possible that these client computers are used in environments with time differences).

The server computer 5 receives power information from each client computer 10, thereby collecting power information of the plural client computers 10. The server computer 5 derives an analysis result of the whole of plural client computers 10 from the collected power information. The analysis result includes the sum and average of power consumption amounts of the plural client computers 10, and the sum and average of the saved power amounts of the plural client computers 10.

As described above, it is possible that the plural client computers 10 are used in different time zones. Thus, for example, when an analysis result of the whole of client computers 10 is to be calculated with respect to a specific day, it is necessary for the server computer 5 to acquire power information of the specific day from each client computer 10, based on the time zones in which the respective client computers 10 are used. In addition, when an analysis result of the whole of client computers 10 is to be calculated with respect to a specific time range of a specific day, it is necessary for the server computer 5 to acquire power information of the specific time range of the specific day from each client computer 10, based on the time zones in which the respective client computers 10 are used.

Thus, the server computer 5 analyzes the power information collected from each client computer 10, considering the time difference from each client computer 10. For example, the server computer 5 receives power information of a specific time range (e.g. from 9:00 to 10:00) in a first time zone from a first client computer used in the first time zone. The server computer 5 also receives power information of the specific time range (e.g. from 9:00 to 10:00) in a second time zone from a second client computer used in the second time zone that is different from the first time zone. By receiving such power information from each client computer 10, the server computer 5 can properly analyze the power information even when plural client computers 10 are used in different time zones.

The server computer 5 transmits an analysis result of the whole of plural client computers 10 to each client computer 10.

The client computer 10 can present to the user the degree of contribution to power saving in the client computer 10 that is being used, by displaying, in a comparable manner, the analysis result of the whole of plural client computers 10, which has been received from the server computer 5, and the power information of this client computer 10.

Incidentally, the above-described cooperation between the client computers 10 and server computer 5 may be realized by cloud computing.

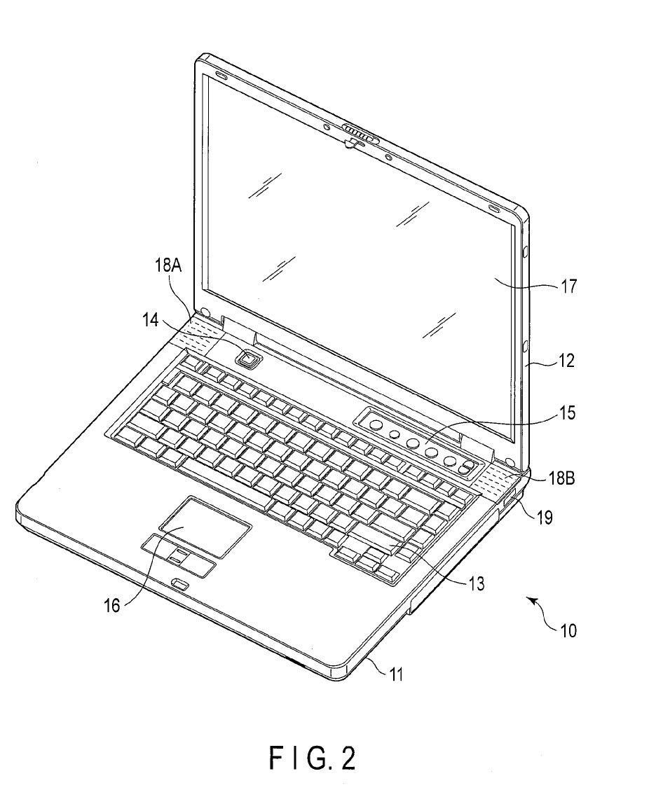

FIG. 2 is a perspective view illustrating an external appearance of the client computer 10. The case is now assumed that the client computer 10 is realized as a notebook-type personal computer.

As shown in FIG. 2, the computer 10 includes a computer main body 11 and a display unit 12. A liquid crystal display (LCD) 17 is built in the display unit 12. The display unit 12 is attached to the computer main body 11 such that the display unit 12 is rotatable between an open position where the top surface of the computer main body 11 is exposed, and a closed position where the top surface of the computer main body 11 is covered with the display unit 12.

The computer main body 11 has a thin box-shaped housing. A keyboard 13, a power button 14 for powering on/off the computer 10, an input operation panel 15, a pointing device 16 such as a touch pad, and speakers 18A and 18B are disposed on the top surface of the housing of the computer main body 11. Various operation buttons are provided on the input operation panel 15.

A universal serial bus (USB) connector 19 is provided on a right side surface of the computer main body 11. Various peripheral devices are connectable to the USB connector 19. An external display connection terminal (not shown) corresponding to, e.g. the high-definition multimedia interface (HDMI®) standard is provided on a rear surface of the computer main body 11. The external display connection terminal is used for outputting a digital video signal to an external display.

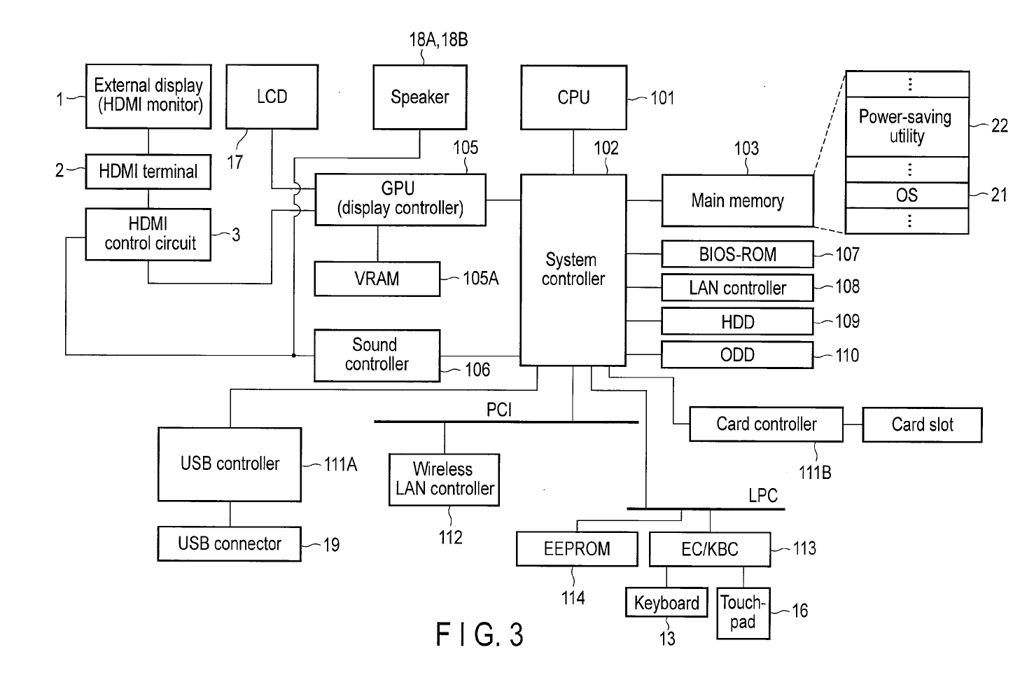

FIG. 3 shows the system configuration of the computer 10.

The client computer 10, as shown in FIG. 3, includes a CPU 101, a system controller 102, a main memory 103, a graphics processing unit (GPU) 105, a video RAM (VRAM) 105A, a sound controller 106, a BIOS-ROM 107, a LAN controller 108, a hard disk drive (HDD) 109, an optical disc drive (ODD) 110, a USB controller 111A, a card controller 111B, a wireless LAN controller 112, an embedded controller/keyboard controller (EC/KBC) 113, and an EEPROM 114.

The CPU 101 is a processor for controlling the operations of the various components in the client computer 10. The CPU 101 executes an operating system (OS) 21, various utility programs and various application programs, which are loaded from the HDD 109 into the main memory 103. The utility programs include a power saving utility program 22.

The power saving utility program 22 is a program for setting values of power saving setting items in power saving setting information in accordance with a user operation, and setting the client computer 10 in a power saving state, based on the set values of the respective power saving setting items. The power saving setting information includes, as the above-described power saving setting items, a plurality of setting items relating to the operation of the client computer 10. These setting items affect the amount of power consumed by the client computer 10. In addition, the power saving utility program 22 includes a function of presenting a degree of contribution to power saving in the client computer 10. For example, the power saving utility program 22 displays, in a comparable manner, information relating to the power saving of the client computer 10, and information relating to the power saving of other client computers (a client computer group).

Besides, the CPU 101 executes a BIOS which is stored in the BIOS-ROM 107. The BIOS is a program for hardware control.

The system controller 102 is a bridge device which connects a local bus of the CPU 101 and the respective components. The system controller 102 includes a memory controller which access-controls the main memory 103. The system controller 102 includes a function of communicating with the GPU 105 via, e.g. a PCI EXPRESS serial bus.

The GPU 105 is a display controller which controls the LCD 17 that is used as a display monitor of the client computer 10. A display signal, which is generated by the GPU 105, is sent to the LCD 17. In addition, the GPU 105 can send a digital video signal to an external display 1 via an HDMI control circuit 3 and an HDMI terminal 2.

The HDMI terminal 2 is the above-described external display connection terminal. The HDMI terminal 2 is capable of sending a digital video signal and a digital audio signal without data compression to the external display device 1, such as a television, via a single cable. The HDMI control circuit 3 is an interface for sending a digital video signal to the external display device 1, which is called “HDMI monitor”, via the HDMI terminal 2.

The system controller 102 controls devices on a peripheral component interconnect (PCI) bus and devices on a low pin count (LPC) bus. The system controller 102 includes an integrated drive electronics (IDE) controller for controlling the HDD 109 and ODD 110. The system controller 102 also has a function of communicating with the sound controller 106.

The sound controller 106 is a sound source device and outputs audio data, which is a target of playback, to the speakers 18A and 18B or the HDMI control circuit 3. The LAN controller 108 is a wired communication device which executes wired communication of, e.g. the IEEE 802.3 standard. On the other hand, the wireless LAN controller 112 is a wireless communication device which executes wireless communication of, e.g. the IEEE 802.11 standard. The USB controller 111A communicates with an external device which is connected via the USB connector 19. The card controller 111B executes data write/read to/from a memory card which is inserted in a card slot provided in the computer main body 11.

The EC/KBC 113 is a one-chip microcomputer in which an embedded controller for power management and a keyboard controller for controlling the keyboard 13 and touch pad 16 are integrated. The EC/KBC 113 has a function of powering on/off the client computer 10 in accordance with the user's operation of the power button 14. The above-described power saving utility program 22 can detect power consumption (or a power consumption amount) of the client computer 10 via the BIOS and EC/KBC 113.

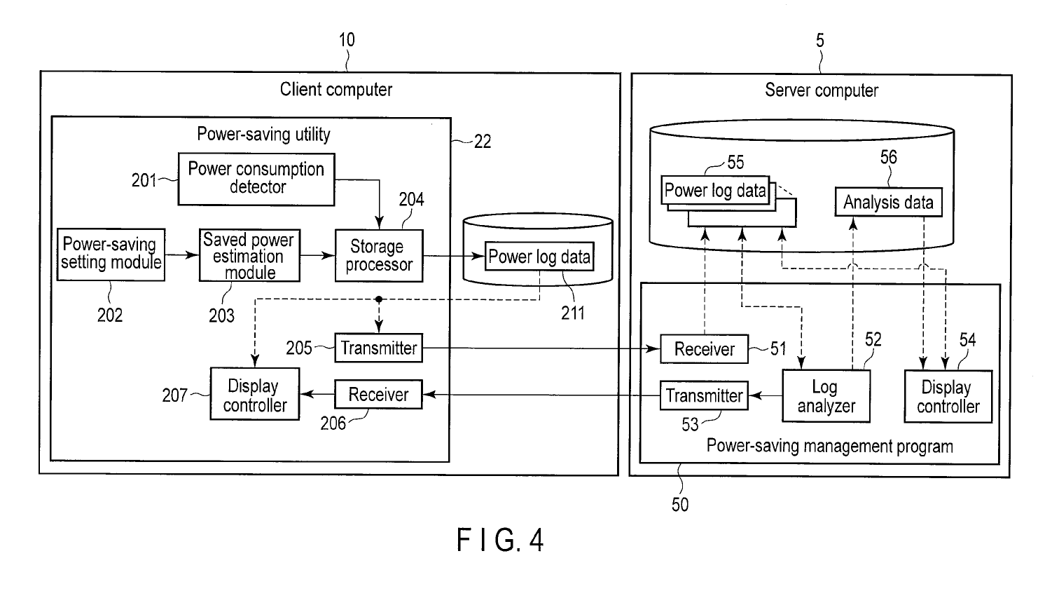

FIG. 4 illustrates an example of the functional configuration of the power saving utility program 22 executed by the client computer 10. The power saving utility program 22 includes a function of setting the client computer 10 in a power saving state, based on the values of power saving setting items, and a function of presenting a degree of contribution to power saving in the client computer 10. In addition, a power saving management program 50, which is executed by the server computer 5, includes a function of analyzing power log data 55 collected from plural client computers 10 and notifying each of the plural client computers 10 of the result of analysis. The power saving utility program 22 and power saving management program 50 operates in cooperation.

The power saving utility program 22 includes, for example, a power consumption detector 201, a power saving setting module 202, a saved power estimation module 203, a storage processor 204, a transmitter 205, a receiver 206, and a display controller 207. The power saving management program 50 includes, for example, a receiver 51, a log analyzer 52, a transmitter 53, and a display controller 54.

The power consumption detector 201 of the power saving utility program 22 detects the power consumption amount of the client computer 10. The power consumption detector 201 detects the power consumption [W] of the client computer 10, for example, via the BIOS or EC/KBC 113, and integrates the detected power consumption, thereby calculating a power consumption amount [Wh] in a predetermined period (e.g. one hour, one day, etc.).

The power saving setting module 202 can set up the values of a plurality of power saving setting items. The respective power saving setting items, which are supported by the power saving utility program 22, are used in order to set up an operational environment of the client computer 10, which affects the amount of power consumed by the client computer 10. The power saving setting items include, for example, the brightness of the screen, the time until turn-off of the display, the time until dimming of the screen, the brightness at the time of dimming of the screen, the time until turn-off of the HDD, and the time until sleep.

The “brightness of the screen” is used in order to control the brightness of the display screen. The range of adjustment of the brightness (luminance) of the display screen is, for example, from level 1 (darkest) to level 100 (lightest).

The “time until turn-off of the display” is used in order to execute control to turn off power to the display at a time of idling. In this setting item, a time from the beginning of idling of the system to the turn-off of power to the display is set.

The “time until dimming of the screen” is used in order to execute control to dim (darken) the display at a time of idling. In this setting item, a time from the beginning of idling of the system to the dimming of the display is set.

The “brightness at the time of dimming of the screen” is used in order to control the brightness of the display screen at the time of dimming of the screen.

The “time until turn-off of the HDD” is used in order to execute control to turn off power to the HDD at a time of idling. In this setting item, a time from the beginning of idling of the system to the turn-off of power to the HDD is set.

The “time until sleep” is used in order to execute control to transition the system to a sleep state (standby state) at a time of idling. In this setting item, a time from the beginning of idling of the system to the transition of the system to the sleep state is set.

The power saving setting module 202 can set the client computer 10 in a power saving state, based on the power saving setting values corresponding to the power saving setting items which are set by the user.

The saved power estimation module 203 estimates a saved power amount by the power saving setting values corresponding to the respective power saving setting items (i.e. the amount of power saved by the present power saving setting values). The saved power estimation module 203 calculates, for example, a difference between a power consumption in a case where one of structural elements in the client computer 10 is set in a normal operation mode, and a power consumption in a case where this structural element is set in a power saving mode. In this way, the saved power estimation module 203 calculates power (saved power) [W] saved when the structural element is set in the power saving mode with respect to each of the structural elements. Then, based on the power saving setting by the power saving setting module 202, the saved power estimation module 203 calculates a saved power amount [Wh] by multiplying the saved power corresponding to the structural element, which is set in the power saving mode, by a time of use of the client computer 10.

The storage processor 204 stores power log data 211 in a storage device. The power log data 211 includes the power consumption amount detected by the power consumption detector 201 and the estimated saved power amount calculated by the saved power estimation module 203.

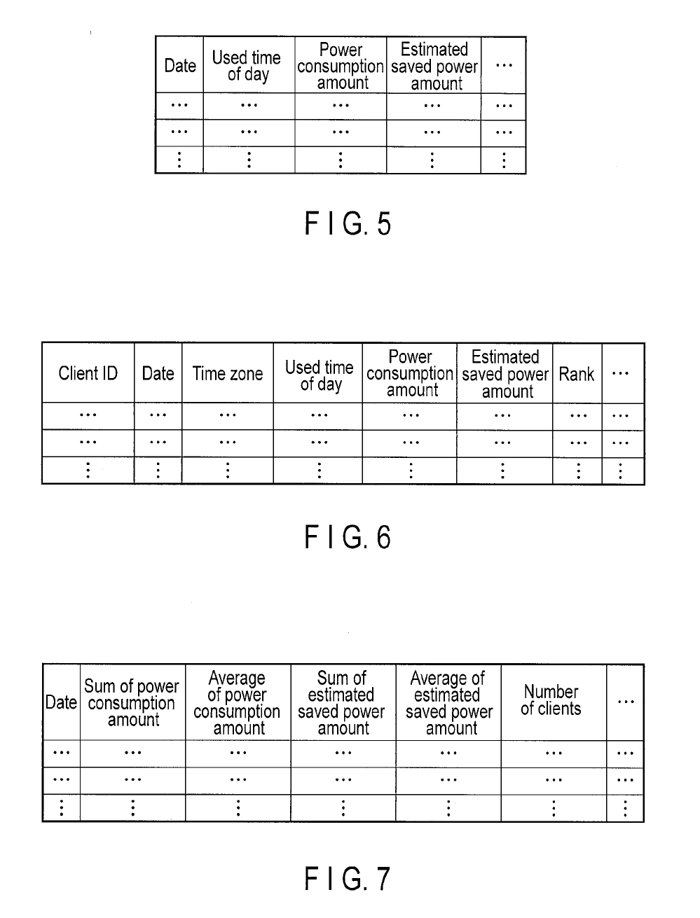

FIG. 5 illustrates a structure example of the power log data 211 stored by the client computer 10 (storage processor 204). The power log data 211 includes a plurality of entries corresponding to a plurality of logs stored at predetermined time intervals. Each of the entries includes, for example, a date, a used time of day, a power consumption amount, and an estimated saved power amount.

In an entry corresponding to a certain period, the “date” is indicative of a date corresponding to this period. The “used time of day” is indicative of a time range corresponding to this period. Specifically, the “date” and “used time of day” indicate a date/time (e.g. “9:00-10:00” of “2013/06/20”), at which power information of this entry was obtained. The “power consumption amount” is indicative of the amount of power consumed by the client computer 10 in this period. The “estimated saved power amount” is indicative of the amount of power which is estimated to have been saved in this period by the client computer 10 set in the power saving state.

The storage processor 204 generates an entry including the power consumption amount detected by the power consumption detector 201 and the estimated saved power amount calculated by the saved power estimation module 203, and then adds this entry to the power log data 211.

The transmitter 205 transmits (uploads) the stored power log data 211 to the server computer 5. For example, when transmission of the power log data 211 has been requested from the server computer 5, the transmitter 205 transmits the entry of the latest power log data 211 (i.e. the entry of power log data 211 which has not yet been transmitted to the server computer 5) to the server computer 5. The transmitter 205 may transmit the entry of the latest power log data 211 to the server computer 5 at predetermined time intervals or at a predetermined time. In the meantime, the transmitter 205 may transmit, together with the entry of the power log data 211, identification information (client ID) of the client computer 10 and information indicative of the time zone (or time difference) of the location where the client computer 10 is used, to the server computer 5.

The receiver 51 of the power saving management program 50, which is executed on the server computer 5, receives the power log data 211 from each of the plural client computers 10, and then stores the descriptions of the received power log data 211 in a storage device. In the meantime, the transmitter 53 may request transmission of the power log data 211 from the client computer 10 at a predetermined timing (e.g. at a predetermined time point), and the receiver 51 may receive the power log data 211 which is transmitted in response to the request.

FIG. 6 illustrates the power log data 55 stored by the server computer 5. The power log data 55 is generated by using the power log data 211 transmitted from the plural client computers 10. It is now assumed that the power log data 211 is transmitted from each of the plural client computers 10 at predetermined time intervals.

The power log data 55 includes a plurality of entries corresponding to a plurality of logs which are stored. Each of the entries includes, for example, a client ID, a date, a time zone, a used time of day, a power consumption amount, an estimated saved power amount, and a rank.

In an entry corresponding to a certain period with respect to a certain client computer 10, the “client ID” is indicative of identification information corresponding to this client computer 10. The “date” is indicative of a date corresponding to this period. The “time zone” is indicative of the time zone of the location where the client computer 10 is used. The “used time of day” is indicative of a time range corresponding to this period. The “date” and “used time of day” are expressed by the date and time in the time zone of the location where the client computer 10 is used.

The “power consumption amount” is indicative of the amount of power consumed by the client computer 10 in this period. The “estimated saved power amount” is indicative of the amount of power which is estimated to have been saved in this period by the client computer 10. The “rank” is indicative of a degree of contribution to power saving of the client computer 10 in this period. For example, the rank of the client computer 10, at a time when the plural client computers are ranked in a descending order of estimated saved power amounts, is set for the “rank”.

The receiver 51 generates an entry in which the client ID and the time zone of the location of use, etc., which are information relating to the client computer 10, are added to the power log data 211 which has been transmitted by the client computer 10, and then adds this entry to the power log data 55. The receiver 51 may use data, which is pre-registered in the server computer 5, as the client ID and the time zone corresponding to the client computer 10, or may receive the client ID and the time zone of the client computer 10 each time the power log data 211 is received from the client computer 10.

Using the power log data 55 stored in the storage device, the log analyzer 52 analyzes, at predetermined time intervals, statistics relating to the power in all client computers in consideration of the time zone (time difference) in which each client computer 10 is used. The log analyzer 52 calculates, for example, the average and sum of power consumption amounts in all client computers, and the average and sum of estimated saved power amounts in all client computers.

To be more specific, for example, it is assumed that the power log data 55 in a specific time of a specific day is analyzed. The specific time of the specific day is designated by the date and time, such as “9:00-17:00” of “2013/06/21”. The log analyzer 52 reads from the storage device entries of the power log data 55 corresponding to client computers 10 in the specific time of the specific day. As described above, in the power log data 55, each entry includes the date and time in the time zone of the associated client computer 10 (the client computer 10 indicated by the “client ID”). Thus, the log analyzer 52 reads from the power log data 55 the entries in which the “date” and “used time of day” correspond to the above-described specific time of the specific day. Thereby, the log analyzer 52 can acquire the entries corresponding to the specific time of the specific day regardless of the time zones of the respective client computers 10.

Based on the value of the “power consumption value” in each of the read entries, the log analyzer 52 calculates the sum and average of the power consumption amounts of the client computers 10 in the specific time of the specific day. In addition, based on the value of the “estimated saved power amount” in each of the read entries, the log analyzer 52 calculates the sum and average of the estimated saved power amounts of the client computers 10 in the specific time of the specific day.

For example, the case is now assumed that the client computers 10 include a first client computer used in a first time zone, and a second client computer used in a second time zone that is different from the first time zone. That is, the location where the first client computer is used and the location where the second client computer is used belong to different time zones.

The log analyzer 52 reads from the power log data 55 the entry which corresponds to a specific time (hereinafter also referred to as “first period”) of a specific day, and is associated with the first client computer. The log analyzer 52 also reads from the power log data 55 the entry which corresponds to a specific time (hereinafter also referred to as “second period”) of a specific day, and is associated with the second client computer. Then, by using the first power consumption amount in the first period by the first client computer and second power consumption amount in the second period by the second client computer in the read entries, the log analyzer 52 calculates the sum and average of these power consumption amounts. In addition, by using the first saved power amount in the first period by the first client computer set in the power saving state and second saved power amount in the second period by the second client computer set in the power saving state that are described in the read entries, the log analyzer 52 calculates the sum and average of these saved power amounts.

The log analyzer 52 further determines the ranking indicative of the degree of contribution to power saving of each client computer 10. The log analyzer 52 ranks the client computers 10, for example, in a descending order of estimated saved power amounts. Specifically, the log analyzer 52 determines the ranking such that the client computer 10 with a maximum estimated saved power amount is placed at the first rank, and the client computer 10 with a minimum estimated saved power amount is placed at the lowest rank. In the meantime, the log analyzer 52 may determine the ranking, based on, instead of this estimated saved power amount, the estimated saved power amount per unit time, or the saved power ratio indicative of the ratio of an estimated saved power amount to a power consumption amount.

FIG. 7 illustrates a configuration example of the analysis data 56 generated by the server computer 5. The analysis data 56 includes entries corresponding to analysis results, for example, in predetermined periods. Each of the entries includes a date, a sum of power consumption amount, an average of power consumption amount, a sum of estimated saved power amount, an average of estimated saved power amount, and the number of clients.

In an entry corresponding to an analysis result in a certain period, the “date” is indicative of a date (or date/time) at which the analysis result was generated. Incidentally, a date, at which data of an analysis target (a power consumption amount, a saved power amount, etc. of each client) was generated, may be set for the “date”.

The “sum of power consumption amount” is indicative of the sum of power consumption amounts in client computers 10, which is included in the analysis result. The “average of power consumption amount” is indicative of an average of power consumption amounts in the client computers 10, which is included in the analysis result. The “sum of estimated saved power amount” is indicative of the sum of estimated saved power amounts in the client computers 10, which is included in the analysis result. The “average of estimated saved power amount” is indicative of an average of estimated saved power amounts in the plural client computers 10, which is included in the analysis result. The “number of clients” is indicative of the number of the client computers 10.

The log analyzer 52 generates entries of the analysis data 56 by using the analysis result of the power log data 55, and then adds the entries to the analysis data 56. In addition, the log analyzer 52 sets the determined ranking of the client computer 10 as a value of the “rank” of the corresponding entry in the power log data 55.

The transmitter 53 transmits to each client computer 10 the average and sum of power consumption amounts in all client computers 10, the average and sum of estimated saved power amounts in all client computers 10, and the rank of the client computer 10 at the destination of transmission.

In the meantime, the display controller 54 can display at least a part of the power log data 55 and analysis data 56 on the screen of the display provided on the server computer 5. Thereby, for example, the administrator who uses the server computer 5 can understand the degree of contribution to power saving in the whole of the client computers 10, and the degree of contribution to power saving in each of the client computers 10.

In addition, the receiver 206 of the client computer 10 (power saving utility 22) receives the average and sum of power consumption amounts in all client computers 10, the average and sum of estimated saved power amounts in all client computers 10, and the rank of this client computer 10. By using the received information and the power consumption amount and estimated saved power amount of the present client computer 10, the display controller 207 displays information indicative of the degree of contribution to power saving on the screen of the LCD 17 or the screen of the external display 1.

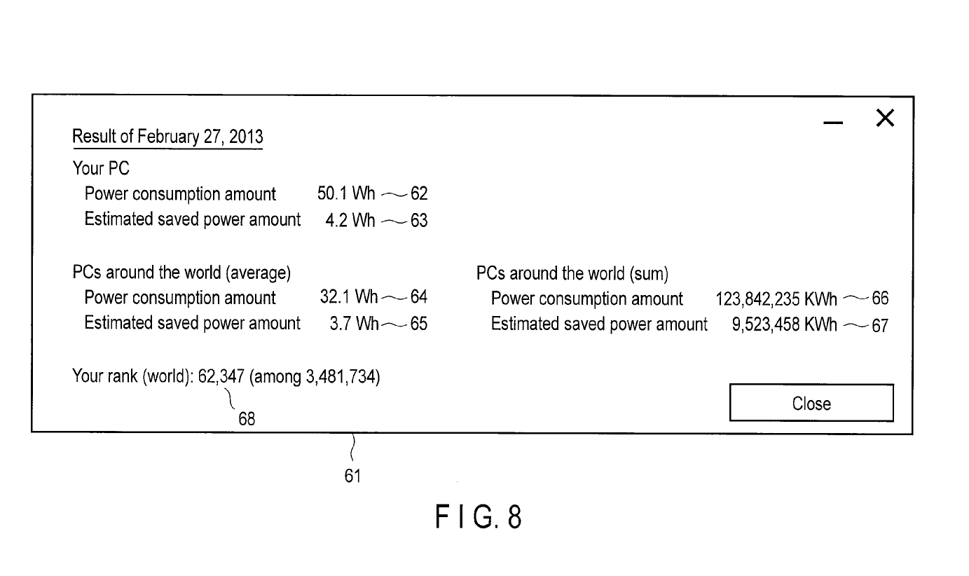

FIG. 8 illustrates an example of a power saving result display screen 61 displaying the degree of contribution to power saving in the client computer 10. The power saving result display screen 61 displays information with respect to a specific period of a specific day (for example, one day). The information includes a power consumption amount 62 and an estimated saved power amount 63 of the client computer 10, and an average of power consumption amount 64 and an average of estimated saved power amount 65 of client computers (e.g. client computers around the world, or client computers belonging to a predetermined group). The information also includes a sum of power consumption amount 66 and a sum of estimated saved power amount 66 of the client computers, and a ranking 68 relating to the degree of contribution to power saving of the client computer 10.

For example, the user can compare the power consumption amount 62 of the client computer 10 which is being used and the average of power consumption amount 64 of the client computers around the world. The user can also compare the estimated saved power amount 63 of the client computer 10 which is being used and the average estimated saved power amount 65 of the client computers around the world. The user can further confirm the ranking relating to the degree of contribution to power saving of the client computer 10 which is being used. Thereby, the user can compare the degree of contribution to power saving of the client computer 10 which is being used by the user himself/herself, and the degree of contribution to power saving of the client computers around the world.

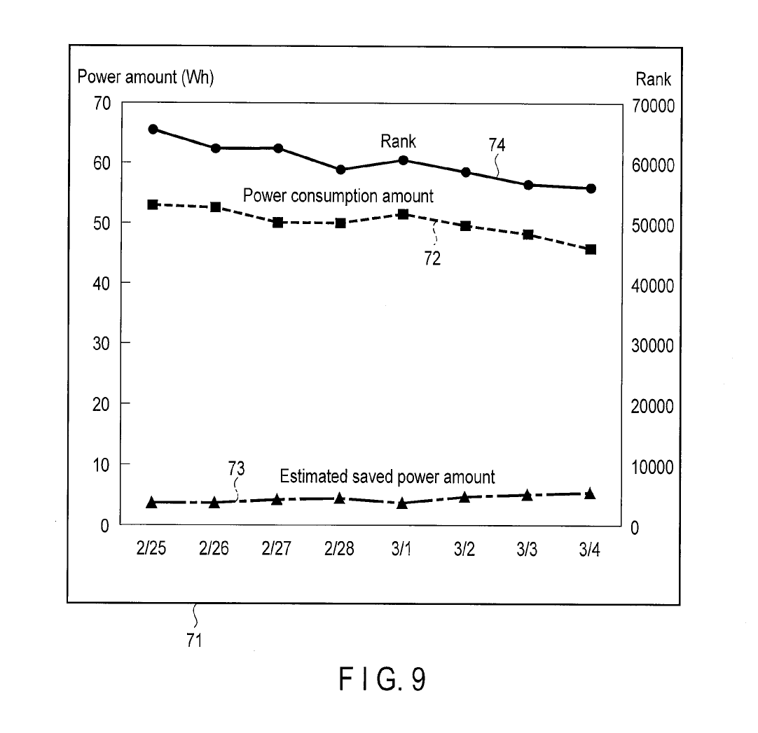

FIG. 9 illustrates an example of a power saving result transition screen 71 which indicates a transition of the power saving result in the client computer 10. In this power saving result transition screen 71, a transition 72 of the power consumption amount, a transition 73 of the estimated saved power amount of the client computer 10, and a transition 74 of the rank relating to the degree of contribution to power saving of the client computer 10, in each predetermined period (e.g. every hour, every day, every week, or every month) are displayed. By the power saving result transition screen 71, the user can understand the tendency of an increase or a decrease of each value. By presenting the power saving result display screen 61 or the power saving result transition screen 71, the user's consciousness of power saving can be improved.

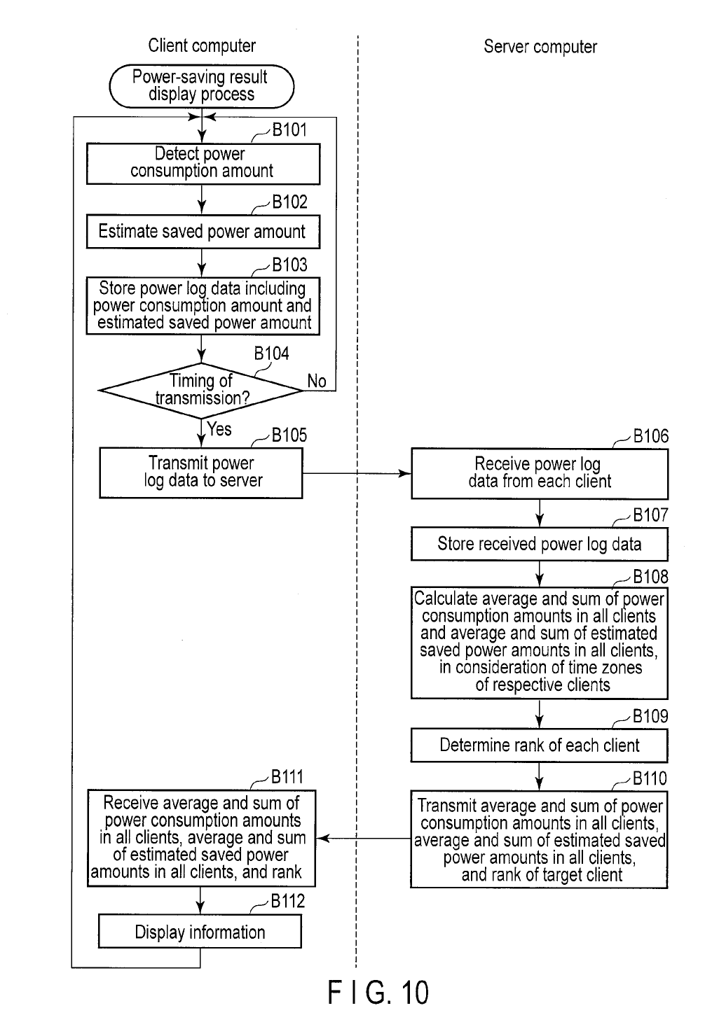

Next, referring to a flowchart of FIG. 10, a description is given of an example of the procedure of a power saving result display process executed by the client computer 10 and the server computer 5.

To start with, the power consumption detector 201, which is provided in the power saving utility 22 executed by the client computer 10, detects the power consumption amount of the client computer 10 (block B101). The power consumption detector 201 detects the power consumption [W] of the client computer 10, for example, via the BIOS or EC/KBC 113, and calculates a power consumption amount [Wh] in a predetermined period (e.g. one hour, one day, etc.) by integrating the detected power consumption.

The saved power estimation module 203 estimates a saved power amount by the present power saving setting in the client computer 10 (i.e. the amount of power saved by the present power saving setting) (block B102). The storage processor 204 stores in the storage device the power log data 211 including the detected power consumption amount and the estimated saved power amount (block B103).

Subsequently, the transmitter 205 determines whether a timing has come to transmit the power log data 211 to the server computer 5 (block B104). The timing to transmit the power log data 211 is, for example, a predetermined time, or a time when transmission of the power log data 211 has been requested by the server computer 5. When the timing has not yet come to transmit the power log data 211 to the server computer 5 (NO in block B104), the process returns to block B101, and the cumulative storage of the power log data 211 is continued.

If the timing has come to transmit the power log data 211 (YES in block B104), the transmitter 205 transmits the stored power log data 211 to the server computer 5 (block B105).

The receiver 51 of the server computer 5 receives the power log data 211 from each of client computers 10 (block B106), and then stores the received power log data 211 in the storage device (block B107).

By using the power log data 55 in the storage device, the log analyzer 52 calculates the average and sum of the power consumption amounts in all client computers 10, and the average and sum of estimated saved power amounts in all client computers 10, considering the time zones (time differences) of the respective client computers 10 (block B108). To be more specific, the log analyzer 52 reads the entries corresponding to a specific time of a specific day (i.e. a specific period) from the power log data 55, the entries being associated with the client computers 10. By using the power consumption amounts in the specific time of the specific day by the client computers 10 indicated in the read entries, the log analyzer 52 calculates the sum and average of these power consumption amounts. In addition, by using the saved power amounts in the specific time of the specific day by the client computers 10 in the power saving state indicated in the read entries, the log analyzer 52 calculates the sum and average of these saved power amounts.

Then, the log analyzer 52 determines the rank in the order based on the degree of contribution to power saving of each client computer 10 (block B109). The log analyzer 52 ranks the client computers 10, for example, in a descending order of estimated saved power amounts (specifically, the client computer 10 with a maximum estimated saved power mount is placed at the first rank, and the client computer 10 with a minimum estimated saved power mount is placed at the lowest rank). In the meantime, the log analyzer 52 may determine the ranking, based on, instead of this estimated saved power amount, the estimated saved power amount per unit time, or the saved power ratio indicative of the ratio of an estimated saved power amount to a power consumption amount.

The transmitter 53 transmits to each client computer 10 the average and sum of power consumption amounts in all client computers 10, the average and sum of estimated saved power amounts in all client computers 10, and the rank of the client computer 10 at the destination of transmission (block B110).

Subsequently, the receiver 206 of the client computer 10 (power saving utility 22) receives the average and sum of power consumption amounts in all client computers 10, the average and sum of estimated saved power amounts in all client computers 10, and the rank of this client computer 10 (block B111). The display controller 207 displays the received information on the screen (block B112).

As has been described above, according to the embodiment, the degree of contribution to power saving can be presented to the user in an easy-to-understand manner. The power saving setting module 202 sets the client computer 10 in a power saving state, based on one or more power saving setting values corresponding to one or more power saving setting items set by the user. The saved power estimation module 203 estimates a first saved power amount in a first period by the client computer 10 being set in the power saving state. The receiver 206 receives from the server 5 an average saved power amount between the first saved power amount and a second saved power amount in a second period by a second client computer being set in the power saving state. The display controller 207 displays the first saved power amount and the received average saved power amount on the screen of the LCD 17 or the screen of the external display 1.

All the procedures of the power saving result display process of the embodiment can be executed by software. Thus, the same advantageous effects as with the present embodiment can easily be obtained simply by installing a computer program, which executes the procedures of the power saving result display process, into an ordinary computer through a computer-readable storage medium which stores the computer program, and by executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a setter configured to set the information processing apparatus in a power saving state, based on one or more power saving setting values corresponding to one or more power saving setting items, the one or more values configured to be set by a user;
an estimator configured to estimate a first saved power amount saved by the information processing apparatus in the power saving state in a first period;
a receiver configured to receive an average saved power amount indicating the average of the first saved power amount and a second saved power amount from a server, the second saved power amount indicating the amount of power saved by a second information processing apparatus in the power saving state in a second period; and
a display controller configured to display the first saved power amount and the received average saved power amount on a screen.

2. The information processing apparatus of claim 1, wherein a location where the information processing apparatus is being used and a location where the second information processing apparatus is being used belong to different time zones.

3. The information processing apparatus of claim 1, further comprising a detector configured to detect a first power consumption amount consumed by the information processing apparatus in the first period,
wherein the receiver is further configured to receive an average power consumption amount indicating the average of the first power consumption amount and a second power consumption amount from the server, the second power consumption amount indicating the amount of power consumed by the second information processing apparatus in the second period, and
the display controller is further configured to display the first power consumption amount and the received average power consumption amount on the screen.

4. The information processing apparatus of claim 1, wherein the receiver is further configured to receive an average saved power amount indicating the average of the first saved power amount and a plurality of saved power amounts, the plurality of saved power amounts respectively indicating the amount of power saved by a plurality of information processing apparatuses comprising the second information processing apparatus in the power saving state in a plurality of second periods.

5. The information processing apparatus of claim 4, wherein a location where the information processing apparatus is being used and a location where the second information processing apparatus is being used belong to different time zones.

6. The information processing apparatus of claim 4, wherein the display controller is further configured to display a rank of the information processing apparatus by ranking the first saved power amount and the plurality of saved power amounts in a descending order.

7. The information processing apparatus of claim 4, further comprising a detector configured to detect a first power consumption amount consumed by the information processing apparatus in the first period,
wherein the receiver is further configured to receive an average power consumption amount indicating the average of the first power consumption amount and a plurality of second power consumption amounts from the server, the plurality of second power consumption amounts respectively indicating the amount of power consumed by the plurality of information processing apparatuses in the plurality of second periods, and
the display controller is further configured to display the first power consumption amount and the received average power consumption amount on the screen.

8. An information processing method comprising:
setting a first information processing apparatus in a power saving state, based on one or more power saving setting values corresponding to one or more power saving setting items, the one or more values configured to be set by a user;
estimating a first saved power amount saved by the first information processing apparatus in the power saving state in a first period;
receiving an average saved power amount indicating the average of the first saved power amount and a second saved power amount from a server, the second saved power amount indicating the amount of power saved by a second information processing apparatus in the power saving state in a second period; and
displaying the first saved power amount and the received average saved power amount on a screen.

9. A computer-readable, non-transitory storage medium having stored thereon a program which is executable by a computer, the program controlling the computer to execute functions of:
setting the computer in a power saving state, based on one or more power saving setting values corresponding to one or more power saving setting items, the one or more values configured to be set by a user;
estimating a first saved power amount saved by the computer in the power saving state in a first period;
receiving an average saved power amount indicating the average of the first saved power amount and a second saved power amount from a server, the second saved power amount indicating the amount of power saved by a second information processing apparatus in the power saving state in a second period; and
displaying the first saved power amount and the received average saved power amount on a screen.
